(19) United States
(12) Patent Application Publication
(10) Pub. No.: US 2008/0033769 A1
(43) Pub. Date: Feb. 7, 2008

(54) Personalized Parking and Reservation System

(76) Inventors: Sailendra Koorapati, Oceanside, CA (US); Venketaraman Chhittoor, Nashik (IN); Jeff Slosar, Henderson, NV (US)

Correspondence Address: LOUIS VENTRE, JR, 2483 OAKTON HILLS DRIVE, OAKTON, VA, 22124-1530, US

(21) Appl. No.: 11/832,031

(22) Filed: Aug. 1, 2007

Related U.S. Application Data
(60) Provisional application No. 60/767,561, filed on Aug. 5, 2006.

(51) Int. Cl. G06Q 10/00; G06Q 30/00

(52) U.S. Cl. 705/5; 705/13

(57) ABSTRACT

A parking facility management, personalized parking and reservation system enabling better parking administration management and further enabling a parking patron to find a recommended parking space most nearly matching his personal preferences and to receive instructions on the shortest path to reach to the available parking space. Electrical signaling sensors (10, 34a, 34b) are employed in parking spaces and aisles. The system includes signal repeaters (26), a microprocessor receiving station (27) employing files and a database on a server readable medium. Secondary software on a computer (31) connected to the microprocessor receiving station (27) manages the microprocessor receiving station, translates the signals, and sends data to files and a database. A ticket dispenser permits entry of parking space preference information. Primary software on the computer (31) enables a parking patron and parking administration management to enter information concerning preferences, parking facility space layout and parking space attributes. The primary software also computes the location of a recommended parking space for a parking patron, compute the vehicles in motion in the aisles; sends a recommended parking space location to the ticket dispenser, provides directions to the recommended parking space, provides periodic executive management reports, and sends instructions to the microprocessor receiving station to integrate data from a plurality of parking facilities into a centralized database.

### FIELD OF INVENTION

In the field of parking facility management, a system and method enhancing management of a parking facility and enabling a parking patron to find a recommended parking space most nearly matching his personal preferences and receive instructions on the shortest path to reach to the available parking space.

### BACKGROUND OF THE INVENTION

“Road rage” has become a familiar term to describe the many inconsiderate and dangerous actions given expression by some drivers against other drivers for reasons varying from aggressiveness to plain stupidity. A new phrase in the lexicon, “parking lot rage,” can be used to describe the growing number of confrontations between drivers trying to find a parking spot.

Unfortunately, parking lot rage is becoming as pervasive and dangerous as road rage. Certain times of the year, such as during a holiday season when mall parking lots are full, tend to bring out the worst in parking lot rage. Also, when it is hot outside or inclement, people race to capture a close in parking spot. Others facing time constraints are stressed, as in those trying to catch a flight but cannot find a parking space. Most people agree parking space protocol is first-come, first-served, but when someone steals a space a driver has been patiently waiting for, or when someone tries to reserve a space for a car that has yet to arrive, tempers flares. Profanities and horns announce displeasure. In the worst cases, physical confrontation, keyed cars and slashed tires contribute to lawlessness and potential liabilities for parking facility owners.

A factor underlying parking lot rage and battles over parking space is the disorganized approach to finding, reserving and using available parking space.

### DESCRIPTION OF PRIOR ART

Systems for aiding in finding and using parking spaces are known in the art. None however, has all of the features, functions, personalization's and improvements on the subject invention.

A recent representative example of the state of the art in this field is U.S. Pat. No. 7,026,954 to John Blake Slemmer, et al. on Apr. 11, 2006. The Slemmer patent describes a system and method for directing parking in a parking lot including detecting the presence of a vehicle in a parking space, identifying the parking space location, and providing the location of the identified available spaces to prospective users in substantially real-time.

The present invention is both different from the prior art by employing numerous innovations and is an improvement over that which is disclosed. In many cases these differences and improvements will be obvious. Nevertheless, some of the more important distinctions relate to what and how it is detected, how the signal reaches the processor, what is done with the detection information, and factoring in parking administration management and parking patron personal variable inputs.

The present invention employs both event-based detection which detects object movement, and polling based detection which is periodic sensing to confirm the status of a parking space in terms of being occupied by a vehicle or a person. In addition, the present invention employs motion detectors in the aisles to sense when objects are moving towards or away from a parking space. This improves reliability of the detection system, aids in the selection of an available parking space, enhances security, and enables a reliable determination of the best route to the parking space.

The present invention employs signal repeaters to lessen the power required for the sensors and for applications with battery powered sensors to dramatically increase the mean-time between battery replacement from a current average of 2 to 3 months to 6-month to 2-years.

The prior art is further distinguished in that the present invention employs software that not only translates the signals but performs eight other important tasks serving the signal purposes of identifying and recommending available and unavailable parking spaces and managing the parking facility in a way that improves profit and better serves the parking patron. As regards managing the parking facility, the software provides periodic, that is for example daily, weekly or monthly, management reports, which may include reports on parking facility utilization, parking re-organization reports, use of optional valet services, handicap spaces utilization, billing assistance activities, safety notations, security events, and navigational system performance.

The prior art is further distinguished in that the present invention utilizes its software to manage a centralized file system and database to more easily integrate parking information and also to provide enhanced capability to manage parking information from multiple parking garages.

The present invention uniquely provides a ticket dispenser that not only prints a ticket, but prints a map and textual instructions showing the parking patron how to get to his personalized recommended parking space and identifying distance and travel time to the parking space. The ticket dispenser also accepts input of the patron's parking space preferences for a space.

Accordingly, the present invention will serve to improve the prior art by helping both the parking patron and the parking facility owner. The parking facility owner better utilizes his parking facility capital assets, promotes customer satisfaction by reducing parking patron stress in finding a parking space, reduces the potential for liabilities from accidents and patron confrontations, enables the detection of persons present in the facility, and provides useful reports to aid in the management of the parking facility. The parking patron is served by the invention by easily and conveniently stating his parking space preferences, quickly identifying available parking space, and receiving easy to understand instruction to finding a parking space. The invention is useful in all manner of parking facilities, from single-level, open-space parking lots to closed, multi-story parking garages. The invention can be used for one facility or may integrate any number of parking lots and garages. Parking facility applications will typically include airports, downtowns, shopping malls, casinos, hospitals, universities, office buildings, stadiums, street parking and many other places.

### BRIEF SUMMARY OF THE INVENTION

A parking facility management, personalized parking and reservation system featuring improved parking administration management and further enabling a parking patron to find a recommended parking space most nearly matching his preferences and to receive instructions on the shortest path to reach to that personalized parking space.

Electrical signaling sensors are employed in parking spaces and aisles. A parking space sensor is dual mode, that is, having event and polling capabilities to distinguish between a person and a vehicle. The aisle sensors detect whether a vehicle is moving in an aisle and transmit signals identifying that status.

The system includes signal repeaters to capture and strengthen signals from sensors and retransmit the signals to a microprocessor receiving station.

The microprocessor receiving station receives the signals originating from each sensor, and is managed by software, termed “secondary software” that resides on a computer connected to the microprocessor receiving station. The secondary software enables the microprocessor receiving station to translate each signal received from a sensor into data. The secondary software also writes that data to a plurality of files and to a database on a server readable medium on the computer.

A ticket dispenser permits entry of parking space preference information and prints a map and textual instructions after the authorization.

Primary software on a computer connected to the microprocessor receiving station enables a parking facility operator to enter setup information concerning parking facility space layout and parking space attributes. The primary software enables the computer to store parking space preference information, compute the location of a recommended parking space for a parking patron based on the parking space attributes and any personal parking space preference information inputted by said parking patron, send information on the location of a recommended parking space to the ticket dispenser, provide directions in a textual format on the shortest path to reach to the recommended parking space, provide a printable display of the map on a monitor, provide a printable display to a computer across the Internet of periodic executive management reports, and integrate data from a plurality of parking facilities into the database.

### BRIEF DESCRIPTION OF THE DRAWINGS

The drawings depict components of the preferred embodiment of the personalized parking and reservation system.

FIG. 1 depicts optional parking space sensor locations.

FIG. 2 depicts signals being transmitted and received.

FIG. 3 illustrates a sensor, repeater, ticket dispenser, radio frequency identification device reader, registration card, microprocessor receiving station and a computer in a parking garage.

FIG. 4 depicts a typical screen display for configuring parking space and preference information.

FIG. 5 depicts a ticket dispenser and a registration card.

FIG. 6 show an illustrative ticket printed receipt and a video display of the output.

FIG. 7 illustrates textual directions to a parking space.

FIG. 8 illustrates the methods for buying a registration card and using it in different parking facilities.

### DETAILED DESCRIPTION

The invention is a system for management, personalized parking and reservation and use of parking facilities, termed “SPARK.” The system enables improved parking facility management through reporting on virtually all data points needed to efficiently operate a parking facility. The system further enables a facility's parking patron to efficiently find an available parking space most nearly matching his preferences and to receive easy to understand instructions on the recommended path to reach to the available parking space.

Sensor. The basic embodiment of the management, reservation and use parking system includes at least one electrical signaling sensor per parking space of a multi-space parking facility. While multiple sensors might be used to perform the function of this sensor, the sensor of the invention has several capabilities, namely to determine status of whether the parking space is occupied or unoccupied and if occupied whether a vehicle or person is occupying it, and to transmit continuous and periodic signals identifying that status. These capabilities are referred to as dual mode capabilities involving event-based detection (depending on the object movement) and polling-based detection (configured for example for detection every 10 minutes) to confirm the parking space is available. Typical electronic signaling sensors are ultrasonic or infrared sensors.

These sensor capabilities provide the means to reliably determine if a vehicle is present in the parking space. If a person is present in the parking space either because the person is transiting the space or simply standing there and waiting, the sensor must be able to detect that and to report that the space is available for vehicle parking. These capabilities further provide enhanced security because they enable detection of whether or not someone is there at a time when no one having a legitimate purpose should be in the facility, or simply in the event of an emergency to determine if anyone is present in the facility that might need rescue.

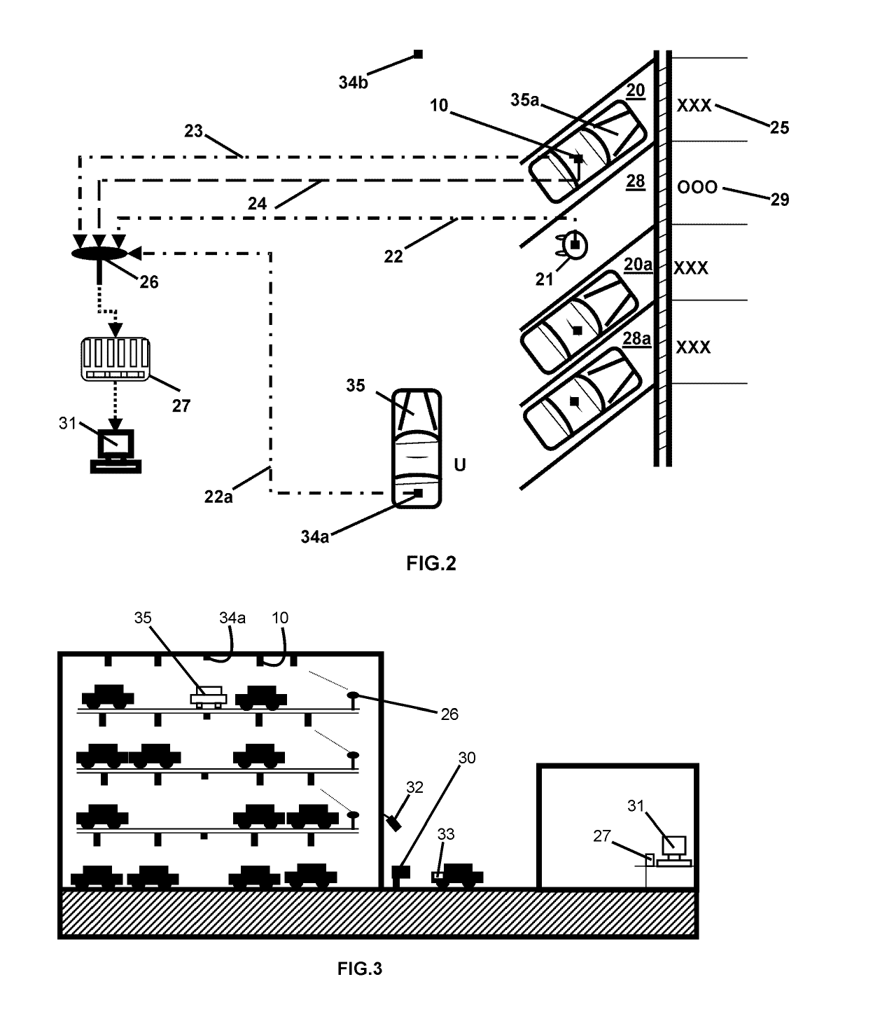

As shown in FIG. 2 and FIG. 3, the preferred embodiment includes at least one electrical signaling sensor (10) per parking space and at least two electrical signaling sensors (34a and 34b) per aisle of a multi-space parking facility. While some embodiments may utilize only one aisle sensor, any such aisle sensor has event based polling capabilities for detecting a moving vehicle and transmitting a signal identifying whether or not a moving vehicle (35) has been detected.

Typical embodiments of the invention would employ a specially designed sensor with low power consumption. A low-power sensor conserves energy and thus lowers operational costs, and minimizes maintenance costs incident to any battery replacement. The sensor may be battery powered or may be hard wired to an electrical supply. If hard wired, it may also have a battery backup.

The preferred embodiment of the sensor employs a wireless transmitting capability to transmit sensor data at a radio signal at 433 megahertz or greater than 2.4 gigahertz. The preferred embodiment includes a sensor with the capability to be programmed to send signals at a programmable interval and to provide a continuous low power signal. The typical dual mode sensor used in the invention has an average mean time between battery replacement of between six months and two years.

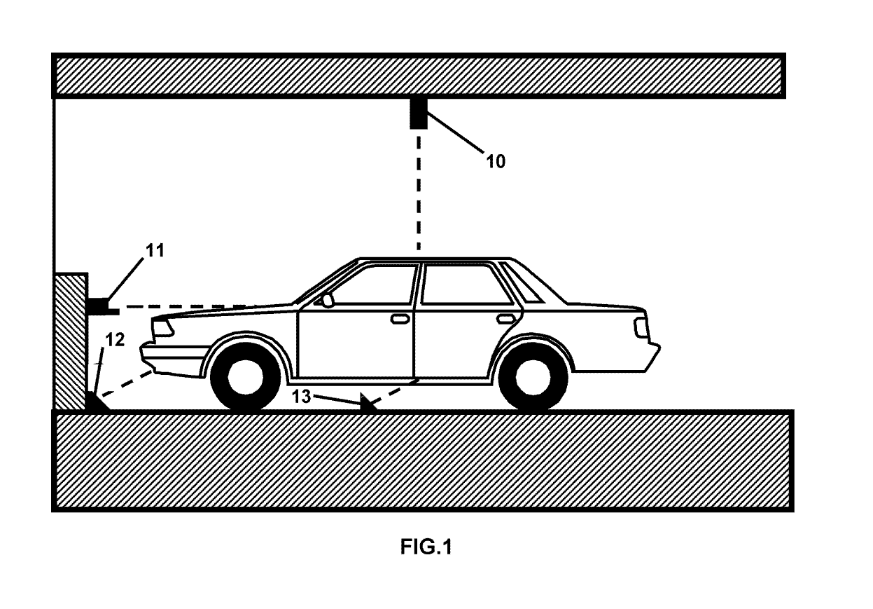

Sensors may be positioned in any convenient location. As shown in FIG. 1, a sensor for a parking space is typically located in any suitable position in a parking space: a ceiling mount (10) for closed parking garages, a wall mount (11), a front floor mount (12) and a center floor mount (13). A sensor may be mounted on a curb when appropriate for open parking spaces.

Repeaters. In the preferred embodiment of the invention, signal repeaters are used to capture and strengthen a signal from any sensor and retransmit the signal to a microprocessor receiving station. The repeater may resend the signal wirelessly or using a wired connection to the microprocessor receiving station. A typical repeater has an antenna to enable signal reception. If the repeater operates via wireless connection to the microprocessor, then an antenna also retransmits the signal to the microprocessor receiving station.

Ticket Dispenser. The preferred embodiment of the invention includes at least one ticket dispenser or kiosk. The ticket dispenser permits input of parking space preference information from a parking patron and is capable of printing a map and textual instructions for driving to a personalized recommended parking space for the parking patron.

A ticket dispenser would typically be located at each entry point to the parking facility, which for a lot might be at a driveway entrance, or for a parking garage might be each street entrance to the garage. In alternative embodiments, the ticket dispenser may be the parking patron's computer and wired or wireless printer.

FIG. 3 shows a typical location of a ticket dispenser (30) at a garage entrance. FIG. 5 shows a typical ticket dispenser (30) with a preference menu (53), a keypad (54), a dispenser slot (55) for delivery of a printed ticket or map, a speaker (56) for communication between the parking administration management and the parking patron, and a slot (57) for insertion of a credit card or a registration card.

In the preferred embodiment, the ticket dispenser is equipped with an input device to allow a parking patron or a parking attendant to enter the parking patron's parking space preference information, such as proximity to an elevator, proximity to emergency stairwell, designated for handicapped use, on a specific garage level, having specific vehicle headroom, having ability to accommodate a specific vehicle size, proximity to a pedestrian entrance, and at a specific parking space location, or any other such preference information deemed appropriate by the parking facility operator or management. The ticket dispenser also provides an option to accept credit cards or the registration card, depending upon parking administration management policies.

Microprocessor receiving station. The preferred embodiment of the system includes a microprocessor receiving station. The microprocessor receiving station is capable of receiving signals originating from the sensors. The microprocessor receiving station is managed by software, herein designated “secondary software,” which resides on a computer connected to the microprocessor receiving station. The secondary software is distinguished from the “primary software” on the computer. The primary software performs the calculations and implements other tasks in running the system. The secondary software translates each signal received from a sensor into data and writes the data to a plurality of files and to a database on server readable medium in the computer. The secondary software is preferably written in code widely understood, such as C++, .NET, and JAVA and using commonly available operating systems such as LINUX, UNIX, and WINDOWS.

The secondary software writes data to the files and to the database either continuously or periodically. A database offers the potential to integrate parking information for multiple parking facilities. A typical database for this application includes ORACLE DATABASE, MICROSOFT SQL, MS ACCESS, DB2, INFORMIX, INGRES, MYSQL, ADS. Typical file formats for the data include txt, tsv, and log. Additional formats for the database and files may be utilized depending on the parking administration management's information technology policies.

Several microprocessor receiving stations may be used in a single parking facility for reliability purposes or in each parking facility in the system. All such microprocessor receiving stations would be capable of communicating between each other to ensure that the data is current in the plurality of files and the database for that facility. Such communicating would typically be mediated by the computers connected to the microprocessor receiving stations.

Database. One database and file system is typically used in a single parking facility regardless of the number of microprocessor receiving stations. When multiple parking facilities are included in the system, each parking facility typically has a database and file system and these separate databases and file systems periodically report to a centralized database and file system that integrates them all.

Primary software. The preferred embodiment of the invention includes primary software for a computer connected to the microprocessor receiving station having certain capabilities. This primary software, like the secondary software, is preferably written in code widely understood such as C++, .NET, and JAVA and using commonly available operating systems such as LINUX, UNIX, and WINDOWS.

The primary software enables parking administration management to enter setup information concerning parking facility space layout and parking space attributes. Generally, this setup information includes parking space specifications in three dimensions, customer use information, parking owners management information systems, security and safety information are setup thru the primary software.

Examples of typical setup information include: the location of a parking space; description of covered or outdoor parking space, identification information for each parking space; proximity of the parking space to an elevator; proximity of the parking space to an emergency stairwell; parking spaces designated for handicapped use; the parking garage level for the space; the maximum vehicle headroom needed to drive to the parking space and park there; the size of the parking space; the proximity of the parking space to a pedestrian entrance; availability of valet services; billing and payment information; safety information; security information; and previously recommended and reserved parking spaces all for one or more parking facilities.

The primary software provides parking administration management with a versatile program that can accommodate a variety of alternatives suited to the variability found in parking facility designs and locations. The primary software also permits the parking administration management to enter parking patron preference information it receives via direct communication from a parking patron, such as via telephone, keypad, Internet, etc.

### EXAMPLE

### Application of the Invention to Parking Garages Using Personalized Parking Preferences

FIG. 2 and FIG. 3 illustrate the case of a ceiling mounted sensor for each parking space in a parking garage. A vehicle (35a) is in a parking space (20). A ceiling mounted sensor (10) sends an event-based signal (23) to the repeater (26) indicating that a vehicle has just parked in the parking space (20). A person (21) is shown in the adjacent parking space (28) immediately below the sensor for that parking space. The sensor above the person also sends an event-based signal (22) indicating that something occupies that parking space. The microprocessor receiving station (27) receives the signals from the repeater (26). The microprocessor receiving station (27) translates the signals into data using secondary software residing on the computer (31). The microprocessor receiving station (27) then sends the data to a computer (31). The computer (31) then stores the data in files and the database on server readable medium in the computer (31).

The computer (31) is managed with primary software, which identifies both parking spaces as occupied. When the polling sensor for the parking space (20) where the vehicle (35a) is parked wakes up it sends a signal (24) that an object is present in parking space (20). The similar polling sensor in the adjacent parking space (28) wakes up but does not find a vehicle or other object because the person has moved on, and so it remains quiet: It does not send any signal to the repeater (26) and this tells the microprocessor that the adjacent spot is empty. The primary software uses the polling data to calculate that parking space (20) is occupied by a vehicle and the lack of polling data for adjacent parking space (28) to calculate that it was occupied by a transient object no longer present.

The primary software then issues instructions to the computer (31) to store the information in the database, such results showing parking space (20) as occupied with the designation “XXX” (25) and parking space (28) as unoccupied with the designation “000” (29).

At the same time, FIG. 3 shows another vehicle (35) driving in an aisle. The aisle event-based sensor (34a) detects this vehicle (35) and sends a signal (22a) to the repeater (26). The other aisle event based sensor (34b) remains quiet indicating to the primary software that no car is driving in its detection range. The event-based sensors in the parking spaces (20, 28, 20a, and 28a) then remain quiet because no new events have triggered a new signal. The primary software managing the computer then uses the absence of subsequent signals in its calculations and stores data identifying the location of the car in the aisle for potential display on a map or video screen designated, for example, with the letter “U,” which is shown next to the vehicle (35) in the aisle in FIG. 3.

If the sensor (34a) were to detect more than one vehicle in the aisle and the other parking space sensors remain quiet, then the primary software would store data that would show two U's one behind the another at that location in that aisle. However, if sensor in parking space (28) detects a new event and sends a signal, then the primary software would use that signal data to calculate that there is only one vehicle in the aisle and the other vehicle parked in parking space (28). And if the other aisle sensor (34b) sends a signal, then the primary software would use that signal data to calculate that there is no vehicle in the aisle.

The primary software issues the instructions to the computer (31) to store parking space preference information obtained from a parking patron on server readable medium in the computer.

The primary software enables the computer to calculate the location of a recommended parking space for a parking patron based on: the parking space attributes; any parking space preference information inputted by the parking patron or parking administration management for the parking patron; how many vehicles are in motion; how many are leaving; and how many vehicles are in transit to the parking facility.

In the preferred embodiment of the invention, the parking administration management assigns weights to each parking space according to its assessment of how the space conforms to preferences that may be specified by a parking patron. The primary software uses those weights to enables the computer to calculate Recommended (RRR), Available (000) and Unavailable (XXX) parking spaces. The symbols RRR, 000 and XXX can be configured in the primary software depending on the parking facilities operators choice. Any other symbols may be used in place of these symbols.

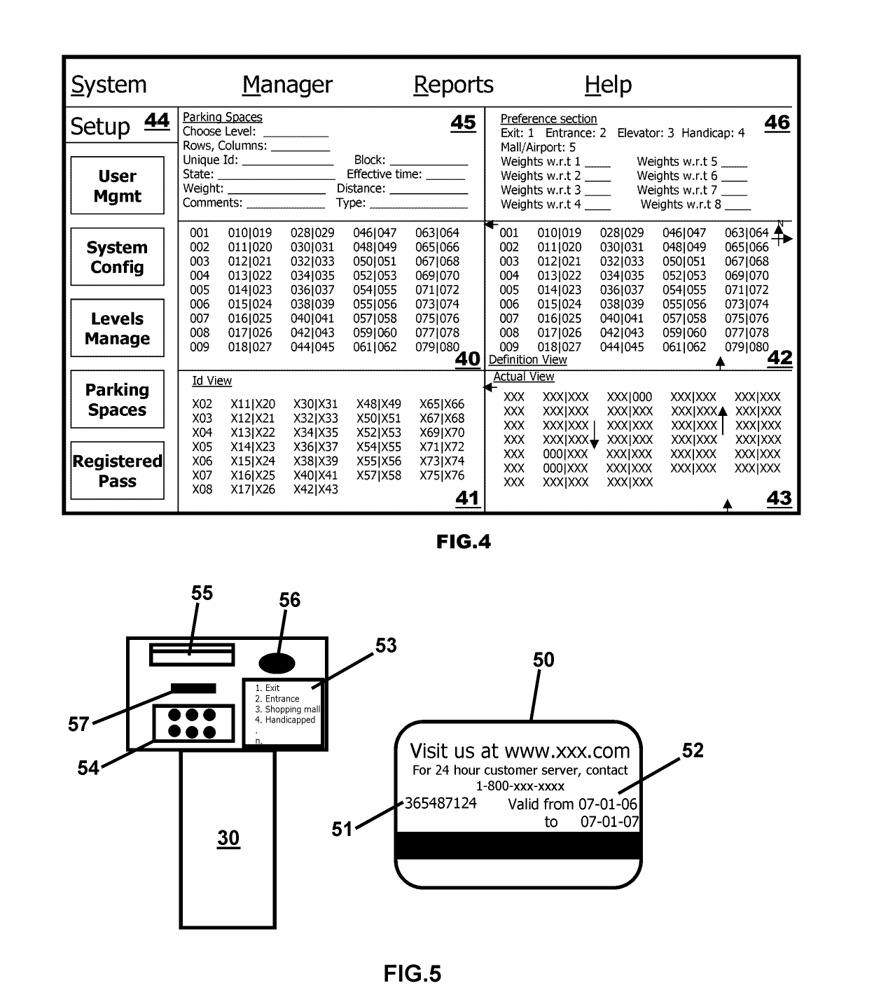

FIG. 4 illustrates a typical setup screen for use by parking administration management. A setup menu (44) at the left of the display screen indicates options for selection. Information entered by management is displayed in boxes (41, 42, 43, 45 and 46). The “Block” field shown in box (45), removes a parking space from being assigned to anyone or permits a designation for special characteristics, such as unusually shaped parking spaces.

FIG. 4 shows that the primary software lays out each parking space on each level in terms of rows and columns and correspondingly given a unique identification designation. The boxes designated (40) (41) and (42) permit different views of the parking space layout. When this data is correlated with the sensor data, box (43) shows whether a space is occupied by an XXX indication, or unoccupied by a 000 indication. An RRR indication would show a recommended space, but is not shown box (43). If there were any cars in-transit they would be shown, for example with a vertical arrow or with U.

FIG. 4 shows other typical entries to configure a parking space in box (45) are “State” to designate available and unavailable parking spaces and is used by management or by the parking patrons with remote access, such as Internet or telephone access, to input a reservation. “Weight” is a designation or points given to an individual parking space to define the space according to a particular profile. For example, if the profile is for a parking space near the exit, a weight is defined to represent this profile. “Distance” is the distance from the entrance or exit of the parking garage. “Comments” is for additional information about the parking space. “Type” is additional characterization information, such as compact car only, handicapped parking space, or reserved during a specific time period for employee parking, but otherwise available to public.

FIG. 4 shows a box (46) for entry of “Preferences.” The preferences and the weights for the parking facility are entered and viewable in this box. These parking facility preferences and weights are used to calculate the weight for a parking patron profile and to calculate the personalized parking space for the parking patron.

The primary software enables the computer to compute the vehicles in motion in the aisles and send the results to the ticket dispenser or to wherever the parking patron is waiting.

The primary software enables the computer to send calculated information on the location of a recommended parking space to the ticket dispenser or to wherever the parking patron is waiting. Such information on the location of a parking space includes recommended and reserved parking spaces for a plurality of parking facilities, which would be especially useful to a parking patron who accesses the system via the Internet or by telephoning the parking administration management. In alternative embodiments, the information is sent to printers, or video displays.

The primary software enables the computer to create directions to the parking space from the location of the parking patron and send those directions to the parking patron. For the preferred embodiment, the directions are sent to the ticket dispenser in a textual format easily understood by the parking patron. FIG. 7 is an example of a typical textual format for the directions (70), including distance and approximate travel time.

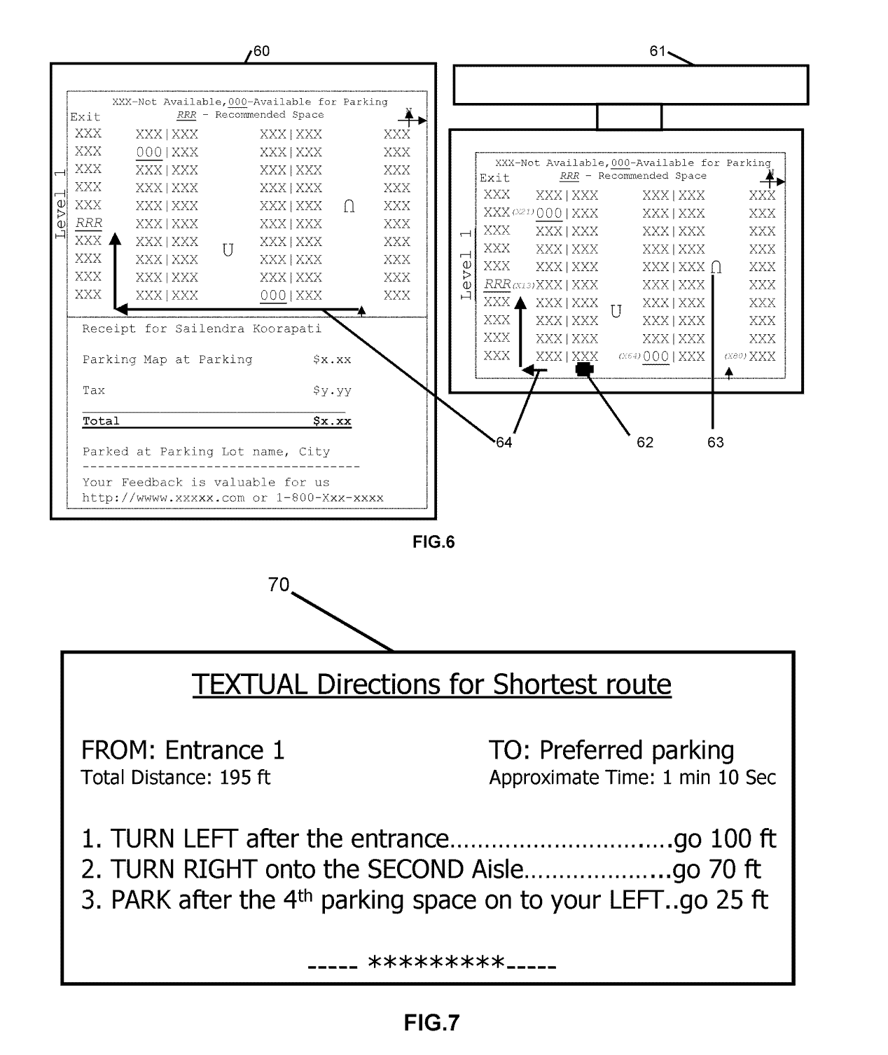

For most embodiments, the directions include a map that may be viewed and printed after authorization is entered. FIG. 6 illustrates a typical map, shown both as printed matter (60) and as a displayed on a video monitor (61). A video monitor, as examples, may be incorporated into a ticket dispenser, may be at a parking patron's computer which is connected to the computer via the Internet, may be a telephone which has Internet capabilities, may be on a parking patron's hand held electronic device which is connected to the computer via the Internet, or may be located in the parking garage at the entrance or at one of numerous other locations so that parking patrons can conveniently check their current location, the next available parking space and the directions to that parking space. The printout and video monitor display typically would have a directional arrow (64) showing a path to the recommended parking space. The video monitor map would also typically show an icon (62) placed where the parking patron's vehicle is currently located to assist the drive in reaching the next available parking space. Other cars in transit in the aisles would also typically be denoted by a “U” (63).

The primary software enables the computer (31) to generate a printable display of periodic executive management reports as may be useful to the management of a parking facility. These reports may be viewed through any device connected to Internet having web browsing capabilities. The primary software enables the computer (31) to send the printable display to another computer, a cell phone or a device connected to the Internet having web browsing capabilities. For example, a utilization report can provide information on the percentage usage of parking facilities, and optimal valet, handicapped, and regular parking spot ratios. These reports can be developed on demand or programmed for daily, weekly, monthly, yearly or other period preparation.

The primary software can also provide information pertinent to parking facility and vehicle security, which can be used by parking administration management and sold as additional vehicle security services to parking patrons. This information is generated using vehicle arrival time, scheduled parking period and scheduled departure time. The system can be further enhanced by adding a means for recording vehicle license plate information. With the integration of license plate information, the police can be provided with information important to identifying the vehicle in public locations. The license plate information also provides an opportunity for parking administration management to identify vehicles which are parked beyond any authorized period of parking or otherwise improperly parked. When combined with historical data on usage and correlated with crime activity, license plate information can be used by security agencies to identify vehicles used in or after a crime.

The primary software directs the computer to integrate data from other databases in the same or other parking facilities as directed by the management.

In alternative embodiments of the invention, the primary software enables the computer to accept parking patron information, including but not limited to reservations for a parking space, from the parking administration management or their agent, from a parking patron through the Internet, and from a parking patron from a telephone. Parking patrons might also reserve a desired parking space well in advance of a projected arrival time.

In alternative embodiments of the invention, the primary software is capable of simultaneously reserving and blocking from use, more than one parking space based on instructions received remotely from a parking patron, including parking spaces located in a multiple parking facilities. A parking patron with a reservation for a parking space has the choice of a pre-assigned parking space or a newly recommended parking space. If the parking patron chooses a newly recommended parking space, then his pre-assigned parking space is unblocked and made available for assignment to others parking patrons.

Registration Card. Alternative embodiments of the invention use a registration card issued to a parking patron to record the parking patron's parking preference information and authorize printing the parking ticket. Parking preference information may include billing, credit and other information about the parking patron. Registration cards may be used in conjunction with payment information to authorize parking by a parking patron, for example on a monthly basis or pursuant to other special parking pass that may be purchased by a parking patron. Regular customers of a particular parking facility or facilities may use the registration card to quickly enter their preference information into the ticket dispenser. For these embodiments, the means for reading the registration card is a card swiping device, or card insertion and reading device integral or connected to the ticket dispenser. Once the registration card is read, the parking patron is typically provided with the option to make any changes desired or simply allow the data previously stored to be used to state his parking preferences.

Use of a registration card enhances the ability to deliver additional services to the parking patron. For example, it allows the parking administration management to notify the parking patron or his designee if the vehicle is moved from the garage earlier than expected. The primary software residing on the computer can optionally have the capability for notification independent of the registration card, but means for acquiring the appropriate contact information for the parking patron would be enhanced by having a registration card.

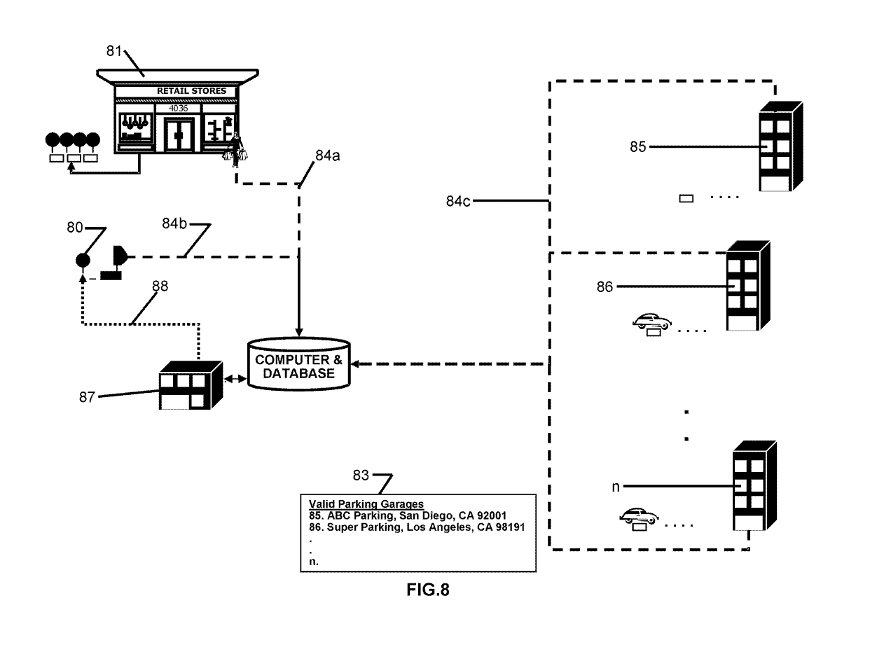

Registration cards would typically be purchased, as shown in FIG. 8, through direct connection (84a, 84b and 84c) to the computer and database via the Internet or telephone. The purchase may be made through a retail store (81) with such a connection (84a). The purchase may be made through the Internet by a parking patron (80) with such a connection (84b). The purchase may be made via a parking facility with such a connection (84c).

The computer and database would alert the parking facility management (87) and an authorized employee would dispatch (88) a registration pass with a list of valid parking facilities (83) to the parking patron.

A reservation for a parking space may be made via similar direct connections. Once made, the reservation is then stored in the database. The parking administration management (87) then dispatches (88) a receipt to the parking patron, which may include, but not be limited to, physical delivery of a ticket, sending an online printed receipt, or sending an email containing an electronic receipt.

The parking patron would then visit one of the valid parking garages (85, 86 . . . n) using the registration card or reservation receipt to be allowed to park in any one of them.

Security. Alternative embodiments of the invention include a means for recording license plate information of a parking patron. This typically means a video camera position to read a license tag upon entry to and exit from a parking facility or making a specific request of the parking patron when the parking patron acquires a registration card. License tag information aids in assisting not only with securing a parking patron's vehicle but also makes it relatively easy to discover already stolen vehicles entering the parking facility.

FIG. 5 illustrates a typical registration card (50) usable in a ticket dispenser (30). This registration card would be imprinted with unique id (51) that is maintained in the database. Every registration card would typically have a validity period (52), that is, a start date and an end date.

RFID. Alternative embodiments use a radio frequency identification tag that is embedded in a registration card. These embodiments also require a means for reading the registration card. This means for reading is a radio frequency identification tag reader (32), which is shown as a stand alone unit in FIG. 3, but may instead be incorporated into the ticket dispenser (30). When the parking patron enters the parking garage in his vehicle with the registration card (33) displayed in the front window of the vehicle, the reader (32) detects the radio frequency identification tag and correlates that with the registration information from the parking patron. If the correlation succeeds, the computer then automatically sends a ticket to the ticket dispenser with the usual printout of the authorized parking space and directions. If the correlation fails, then the patron can utilize other available means to request parking authorization. Another use for these embodiment is integration with radio signal highway toll based systems, such as E-ZPASS.

Payment. In some embodiments of the invention, the ticket dispenser has the capability to read a credit card from the patron, which facilitates payment for parking services.

Preferences. The preferred embodiment of the invention permits a patron to enter parking preference information via the ticket dispenser. This is typically done via a keypad or touch screen. Alternative embodiments permit the input of a parking preference by the parking patron telephoning the parking management or their agent and the management or agent entering the data into the system. Other embodiments permit parking patron access to the system to enter preferences via an Internet connection.

FIG. 3 illustrates an installation of the invention in a parking garage. A dual-mode sensor (10) is installed in a ceiling mounted position above each parking space. A repeater (26) is shown on each parking garage level. A microprocessor receiving station (27) is located inside an office. The microprocessor receiving station is shown connected to a computer (31), which provides access to the files and database through the secondary software. The computer may be a server, a laptop computer, a desktop computer, or such other device as is capable of interacting with the microprocessor receiving station and running the primary and secondary software. A ticket dispenser (30) is installed at an entrance to the parking garage.

Method of Using. The steps for the method of this invention do not necessarily have to be performed in the order in which they are listed, but rather may be in any order suited to operation of the parking facility.

The preferred method of using the invention would nominally start with the parking administration management installing and operating the system and using the sensors to detect any vehicles in parking spaces in a parking facility and any open parking spaces which may be assigned to newly arriving parking patrons. Each sensor send its signals to a repeater. The repeater receives the signal from each sensor and transmits the received signal to a microprocessor receiving station where the signal is received. The secondary software then translates the signal to data, which is written to at least one log file and a database. The parking patron then sends a request for a parking space which includes any parking preference selections. Typically, this request may be at a ticket dispenser directly at the parking garage entrance or via the Internet, or from a telephone call. The primary software residing on the computer thereupon calculates recommended parking space information for that parking patron. The primary software residing on the computer then verifies the parking patron payment information. If payment has been made, the primary software directs the computer to send the recommended parking space information and receipt to the parking patron. The parking space information includes directions to the recommended parking space, usually in a textual and map format, which may be printed or displayed by the parking patron. Finally the primary software directs the computer to store information on this transaction to a file and the database.

The above-described embodiments including the drawings are examples of the invention and merely provide illustrations of the invention. Other embodiments will be obvious to those skilled in the art. Thus, the scope of the invention is determined by the appended claims and their legal equivalents rather than by the examples given.

What is claimed is:

1. A parking facility management, personalized parking and reservation system comprising,
(a) at least one electrical signaling sensor per parking space of a multi-space parking facility, said sensor having the capabilities to determine status of whether the parking space is occupied or unoccupied and if occupied whether a vehicle or person is occupying it, and to transmit continuous and periodic signals identifying that status;
(b) at least one electrical signaling sensor per aisle of a multi-space parking facility with event based polling capabilities for detecting a moving vehicle and transmitting a signal identifying whether or not a moving vehicle has been detected;
(c) a plurality of repeaters having an antenna to capture and strengthen a signal from any sensor and retransmit said signal to a microprocessor receiving station;
(d) at least one ticket dispenser permitting input of parking space preference information from a parking patron and capable of printing a map and textual instructions for driving to a personalized recommended parking space;
(e) at least one microprocessor receiving station capable of receiving signals originating from the sensors and managed by secondary software residing on a computer connected to the microprocessor receiving station, said secondary software translates each signal received from a sensor into data and writes the data to a plurality of files and to a database on server readable medium on the computer; and
(f) primary software for the system operable by the computer, such primary software to
enable parking administration management to enter setup information concerning parking facility space layout, parking space attributes, and preferences from a parking patron;
store parking space preference information;
compute the location of a recommended parking space for a parking patron based on the parking space attributes and the any personalized parking space preference information inputted by said parking patron;
compute the vehicles in motion in the aisles;
send information on the location of a recommended parking space to the parking patron;
provide directions for the shortest path to reach to the recommended parking space in both textual and graphical map format;
provide a printable display to a computer across the Internet of periodic executive management reports; and
integrate data from one or more parking facilities into the files and the database.

2. The system of claim 1 further comprising a registration card issued to a parking patron to permanently record the parking patron's parking preference information and a means for reading the registration card.

3. The system of claim 2 wherein the ticket dispenser has the capability to read the registration card by swiping the registration card.

4. The system of claim 2 wherein the registration card records payment information and authorization for parking by the parking patron.

5. The system of claim 1 further comprising a reader of a radio frequency identification chip which is provided in one of a group consisting of the ticket dispenser and a stand alone unit.

6. The system of claim 1 wherein the ticket dispenser has the capability to read a credit card from the patron.

7. The system of claim 1 further comprising a video monitor within the parking facility to enable parking patrons to check their current location, the recommended parking space, the next available parking space and the directions to that parking space.

8. The system of claim 1 further comprising a means for recording license plate information of a parking patron.

9. The system of claim 1 wherein the primary software further enables the computer to record parking patron information entered by one selected from of a group consisting of parking administration management, an agent of parking administration management, a parking patron through the Internet, a retail store via the Internet, a retail store via telephone, and a parking patron via a telephone.

10. The system of claim 1 wherein the sensor is a wireless sensor capable of transmitting a radio signal at a frequency selected from a group consisting of 433 megahertz and greater than 2.4 gigahertz.

11. The system of claim 1 further comprising one or more additional microprocessor receiving stations, wherein the number of said microprocessor receiving stations is proportional to the number of entrances in a parking facility complex and wherein any of said microprocessor receiving stations can communicate with any other microprocessor receiving station in said complex.

12. The system of claim 1 wherein the files and database are updated continuously.

13. The system of claim 1 wherein the files and database are updated periodically.

14. The system of claim 1 wherein the input of a parking preference is by means selected from a group consisting of a parking facility operator, keypad, a touch screen, telephone call, an Internet connection, registration card, a radio frequency identification device reader and a credit card.

15. The system of claim 1 wherein a personalized parking preference input is selected from a group consisting of proximity to an elevator, proximity to emergency stairwell, designated for handicapped use, on a specific garage level, having specific vehicle headroom, having ability to accommodate a specific vehicle size, proximity to a pedestrian entrance, and at a specific parking space location.

16. The system of claim 1 wherein the primary software has the further capability to notify the parking patron if the vehicle is moved from the garage earlier than expected.

17. The system of claim 1 wherein the primary software and secondary software are written in code selected from a group consisting of C++, .NET, and JAVA.

18. The system of claim 1 wherein information on the location of a parking space includes recommended and reserved parking spaces for a plurality of parking facilities.

19. The system of claim 1 wherein the primary software is capable of simultaneously reserving and blocking one or more parking spaces based on instructions received remotely from a parking patron, including parking spaces located in a plurality of parking facilities.

20. The system of claim 19 wherein the parking patron may change any reserved and blocked parking space at any time.

21. A process of using the system of claim 1 comprising the steps of,
(a) detecting any vehicles in parking spaces in a parking facility using sensors;
(b) receiving a signal from each sensor at a repeater;
(c) transmitting the signal received by the repeater to a microprocessor receiving station;
(d) receiving the signal from the repeater at the microprocessor receiving station;
(e) writing data from signal translation to a log file and database;
(f) receiving a request for a parking space from a parking patron which includes any parking preference selections;
(g) calculating recommended parking space information using any personalized parking preference information expressed by the parking patron;
(h) verifying parking patron payment information;
(i) sending the recommended parking space information and receipt to the parking patron;
(j) displaying directions at the parking patron's location as to the shortest path to the recommended parking space in the context of the parking facility; and
(k) storing data regarding the parking patron and recommended parking space in a centralized database.
